(19) United States
(12) Patent Application Publication
(10) Pub. No.: US 2014/0281015 A1
(43) Pub. Date: Sep. 18, 2014

(54) Post-Scheduling Ad Hoc Sequencing Of File Transfers

(71) Applicant: CAREFUSION 303, INC., San Diego, CA (US)

(72) Inventors: Martin Orona, San Diego, CA (US); Aron Weiler, San Diego, CA (US)

(73) Assignee: CAREFUSION 303, INC., San Diego, CA (US)

(21) Appl. No.: 13/829,577

(22) Filed: Mar. 14, 2013

(51) Int. Cl. H04L 29/06

(52) U.S. Cl. CPC H04L 65/1013
USPC 709/232

(57) ABSTRACT

The subject matter disclosed herein provides methods for transferring files from a file transfer queue and modifying the file transfer sequence. In one aspect, the method can include maintaining a file transfer queue of at least one file. The file transfer queue can include a plurality of queue positions including a top position, and each queue position can store one of the files. Each file can be associated with a transfer destination device and a delivery parameter. The delivery parameter can indicate a delivery priority. The method can further include moving a file to the top position based on the associated delivery parameter, determining whether the transfer destination devices associated with the file in the top position is connected to a network, and transferring the file in the top position to the associated transfer destination device based on the determining. Related apparatus, systems, techniques and articles are also described.

### TECHNICAL FIELD

The subject matter described herein relates to the transfer of files to devices connected to a hospital network and, more particularly, to the sequencing of file transfers.

### BACKGROUND

In many healthcare environments, hundreds, if not thousands, of devices can be connected to a computing network having a central server. The central server can be responsible for managing and transferring important files to devices across the network. These files can contain information essential to the operation of these devices including, for example, data sets, syringe lists, software and/or firmware updates, and the like.

The central server can use a file transfer queue to coordinate the sequence in which files are transferred. Different methodologies can be used to coordinate the file transfer sequence including, for example, a first in, first out mechanism. In this mechanism, files can be transferred based on the order in which they are added to the file transfer queue. This mechanism assumes that no one file is more valuable than another. In the healthcare setting, however, this assumption may not be valid. If, for example, a medical device urgently needs a data set for immediate use in an emergency procedure, the transfer of this data set may be more urgent than the transfer of a routine software update that is located higher up the file transfer queue.

### SUMMARY

In some implementations, methods and apparatus, including computer program products, and systems are provided for the transfer of files from a file transfer queue and the modification of the file transfer sequence.

In one aspect, a file transfer queue of at least one file is maintained. The file transfer queue includes a plurality of queue positions including at least a top position. Each queue position stores one of the files, and each file is associated with a transfer destination device and a delivery parameter. The delivery parameter indicates a delivery priority. At least one of the files in the top position is moved to the top position based on the file's delivery parameter. A determination is made as to whether each of the transfer destination devices associated with the at least one file in the top position is connected to a network. Based on this determination, the at least one file in the top position is transferred to the associated transfer destination device.

The above methods, apparatus, computer program products, and systems can, in some implementations, further include one or more of the following features.

The determining can further include querying each of the transfer destination devices associated with the at least one file in the top position for an indication of whether the transfer destination device is willing to accept a file.

The moving of the at least one file to the top position can occur when the associated delivery parameter indicates that the at least one file is to be immediately transferred. The moving of the at least one file to the top position can also occur when the associated delivery parameter of the at least one file indicates a delivery date and delivery time that matches the current network date and current network time.

The delivery parameter can indicate a default delivery methodology. In some implementations, the default delivery methodology can be a first in, first out mechanism.

The number of files that are simultaneously transferred can be limited. The limiting can be based on predetermined maximum number of files, a predetermined maximum combined file size, or a maximum network throughput value. After the transferring, any remaining files in the file transfer queue can be shifted by a single queue position towards the top position.

The at least one of the transfer destination devices can include a medical device. The at least one file can include a data set, which when accessed by the medical device can cause at least one configuration setting of the medical device to be modified. In some implementations, if the medical device is a syringe pump, then the data set can include a syringe list that specifies at least one setting associated with at least one syringe. The at least one file can also include a software update, or a firmware update.

Computer program products are also described that comprise non-transitory computer readable media storing instructions, which when executed one or more data processor of one or more computing systems, causes at least one data processor to perform operations herein. Similarly, computer systems are also described that can include one or more data processors and a memory coupled to the one or more data processors. The memory can temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The subject matter described herein provides many advantages. For example, in some implementations, a file transfer manager can be used to coordinate the sequence in which files are transferred to devices in a healthcare computing network. Using this file transfer manager, a hospital administrator can designate certain files for immediate transfer and can schedule the transfer of other files to occur at a particular date and time.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated herein and constitute a part of this specification, show certain aspects of the subject matter disclosed herein and, together with the description, help explain some of the principles associated with the subject matter disclosed herein. In the drawings,

FIG. 1 is a system diagram illustrating a computing landscape within a healthcare environment;

FIG. 2 illustrates a graphical depiction of the transfer of files from a file transfer queue to medical devices connected to a network;

FIGS. 3A, 3B, and 3C illustrate a file transfer queue;

FIGS. 4A, 4B, 4C, and 4D illustrate different implementations for adjusting a file's delivery parameter; and

FIG. 5 illustrates a flowchart for transferring a file from a file transfer queue.

Like reference symbols in the various drawings indicate like elements.

### DETAILED DESCRIPTION

The subject matter disclosed herein relates to the maintaining of a file transfer queue that designates the sequence in which files are transmitted across a network. In some implementations, this file transfer sequence can be modified by adjusting a file's delivery parameter. This delivery parameter can indicate, for example, that a file should be transferred immediately or at a scheduled date and time.

FIG. 1 is a system diagram illustrating a computing landscape 100 within a healthcare environment such as a hospital. Various devices and systems, both local to the healthcare environment and remote from the healthcare environment, can interact via at least one computing network 105. This computing network 105 can provide any form or medium of digital communication connectivity (i.e., wired or wireless) amongst the various devices and systems. Examples of communication networks include a local area network (“LAN”), a wide area network (“WAN”), and the Internet. In some cases, one or more of the various devices and systems can interact directly via peer-to-peer coupling (either via a hardwired connection or via a wireless protocol such as Bluetooth or WiFi). In addition, in some variations, one or more of the devices and systems communicate via a cellular data network.

In particular, aspects of the computing landscape 100 can be implemented in a computing system that includes a back-end component (e.g., as a data server 110), or that includes a middleware component (e.g., an application server 115), or that includes a front-end component (e.g., a client computer 120 having a graphical user interface or a Web browser through which a user can interact with an implementation of the subject matter described herein), or any combination of such back-end, middleware, or front-end components. A client 120 and servers 110 and 115 are generally remote from each other and typically interact through the communications network 105. The relationship of the clients 120 and servers 110, 115 arises by virtue of computer programs running on the respective computers and having a client-server relationship to each other. Clients 120 can be any of a variety of computing platforms that include local applications for providing various functionality within the healthcare environment. Example clients 120 include, but are not limited to, desktop computers, laptop computers, tablets, and other computers with touch-screen interfaces. The local applications can be self-contained in that they do not require network connectivity and/or they can interact with one or more of the servers 110, 115 (e.g., a web browser).

A variety of applications can be executed on the various devices and systems within the computing landscape such as electronic health record applications, medical device monitoring, operation, and maintenance applications, scheduling applications, billing applications and the like.

The network 105 can be coupled to one or more data storage systems 125. The data storage systems 125 can include databases providing physical data storage within the healthcare environment or within a dedicated facility. In addition, or in the alternative, the data storage systems 125 can include cloud-based systems providing remote storage of data in, for example, a multi-tenant computing environment. The data storage systems 125 can also comprise non-transitory computer readable media.

Mobile communications devices (MCDs) 130 can also form part of the computing landscape 100. The MCDs 130 can communicate directly via the network 105 and/or they can communicate with the network 105 via an intermediate network such as a cellular data network 135. Various types of communication protocols can be used by the MCDs 130 including, for example, messaging protocols such as SMS and MMS.

Various types of medical devices 140 can be used as part of the computing landscape 100. These medical devices 140 can comprise, unless otherwise specified, any type of device or system with a communications interface that characterizes one or more physiological measurements of a patient and/or that characterize treatment of a patient. In some cases, the medical devices 140 communicate via peer to peer wired or wireless communications with another medical device 140 (as opposed to communicating with the network 105). For example, the medical device 140 can comprise a bedside vital signs monitor that is connected to other medical devices 140, namely a wireless pulse oximeter and to a wired blood pressure monitor. One or more operational parameters of the medical devices 140 can be locally controlled by a clinician, controlled via a clinician via the network 105, and/or they can be controlled by one or more of a server 110 and/or 115, a client 120, a MCD 130, and/or another medical device 140.

The computing landscape 100 can provide various types of functionality as can be required within a healthcare environment such as a hospital. For example, a central server, such as application server 115, can push a variety of files to the various hosts connected to network 105. These files can include, for example, data sets, syringe lists, configuration files, and/or language settings for medical devices 140; software and/or firmware updates for clients 120; and patient alerts for MCD 130. Some of these file transfers can be more urgent than others. For example, the transfer of an emergency data set update for a medical device 140 being used in surgery may be more urgent than the transfer of a software update to a client 120. Application server 115 can run an application, such as a file transfer manager, to coordinate and prioritize the transfer of these files using a file transfer queue.

FIG. 2 illustrates a graphical depiction of the transfer of files from file transfer queue 205 to medical devices 230, 235, and 240. File transfer queue 205 can contain a variety of slots or queue positions 210, 215, and 220. A hospital administrator can use a file transfer manager to populate queue positions 210, 215, and 220 with files stored in data storage 125. In the example of FIG. 2, files A, B, and C can be stored in queue positions 210, 215, and 220, respectively. In some implementations, file transfer queue 205 can store address pointers to the stored locations of files A, B, and C in data storage 125 rather than the files themselves. Although queue positions 210, 215, and 220 are illustrated as storing a single file each, any number of files can be stored in each queue position.

Each of the files stored in file transfer queue 205 can be transferred to a transfer destination device. As indicated by the arrows in the example of FIG. 2, files A, B, and C can be transferred to medical devices 230, 240, and 235, respectively. The file transfer manager can coordinate the sequence in which files A, B, and C are transferred based on each file's delivery parameter. The delivery parameter can indicate a delivery priority associated with a file. In the example of FIG. 2, file A can have a delivery parameter that indicates that it is to be immediately transferred, and file B can have a delivery parameter that specifies a predetermined transfer date and time. A hospital administrator can assign delivery parameters to files A and B when these files are first added to file transfer queue 205 or anytime thereafter. In some implementations, a file may not be associated with any delivery parameter at all. In these implementations, the file can be transferred based on the order in which it was added to file transfer queue 205. For example, if file C is added to file transfer queue 205 after files A and B, then file C can be transferred after files A and B are transferred. This default sequence, which transfers files based on the order in which they are added to the file transfer queue, can correspond to a first in, first out delivery system.

FIG. 3A illustrates another representation of file transfer queue 205. In this example, a file name 305, a transfer destination 310, and a delivery parameter 315 can be displayed for each file in the queue. File transfer queue 205 can define the order in which files are transferred based on each file's queue position. In some implementations, files can only be transferred from top queue position 320. Accordingly, files that occupy queue positions near the top of file transfer queue 205 are eligible for transmission before files in lower queue positions. When a file is added to file transfer queue 205, it can be placed at the bottom of the queue. As files in higher queue positions are transferred, this file can incrementally move up the queue towards top position 320. Once the file reaches top position 320, it can be immediately transferred to its transfer destination.

In the example of FIG. 3A, data set A can be immediately transferred to device 1 because this file occupies top position 320. Once data set A is transferred, the entry for this file can be deleted from top position 320.

To fill this vacancy, the file transfer manager can shift configuration file B into top position 320 as illustrated in FIG. 3B. Once configuration file B shifts into top position 320, its delivery parameter 315 can be updated to indicate that the file can be immediately transferred to device 2. Shifting configuration file B into top position 320 can leave a vacancy in queue position 325 which can be filled by data set B. Likewise, any remaining files in transfer queue 205 can be shifted up towards top position 320 by a single queue position.

After configuration file B is transferred to device 2, the entry for this file can be deleted from top position 320, and data set B can move into the top position as illustrated in FIG. 3C. Once data set B shifts into top position 320, its delivery parameter 315 can be updated to indicate that the file can be immediately transferred to device 3. This cycle can repeat itself until all files in file transfer queue 205 have been transferred to their respective destinations.

In the examples of FIGS. 3A-3C, files can be immediately transferred to their respective destination devices upon reaching top position 320. In some implementations, the file transfer manager can additionally determine whether each file's respective destination devices are connected to network 105 before transferring the files. The file transfer manager can, for example, ping the destination device of the file in top position 320 to determine its connectivity to network 105. In some implementations, the file transfer manager can additionally query whether connected destination devices are willing to accept a file. If a reply is received that indicates that the destination device is connected to network 105 (or connected and willing to accept a file), then the file transfer manager can transfer the file to the destination device. If, however, a reply is not received (or a connected destination device indicates that it cannot accept a file), then the file transfer manager can delete the file from file transfer queue 205 without transferring it. In some implementations, the file transfer manager can resend a predetermined number of pings before deleting the file from file transfer queue 205.

As described above, the order in which files are transferred from top position 320 can correspond to the order in which the files appear in file transfer queue 205. In the examples of FIGS. 3A-3C, data set A can be transferred before configuration file B which, in turn, can be transferred before data set B. This default transfer sequence can correspond to a first in, first out mechanism. In some implementations, a hospital administrator can modify this default transfer sequence. This need can arise, for example, if data set B is urgently needed at device 3 for an emergency surgery in the configuration of FIG. 3A. In this example, data set B can be transferred immediately with data set A and before configuration file B.

The file transfer sequence can be modified by adjusting a file's delivery parameter. As explained above, a delivery parameter can represent a delivery priority for a particular file. FIGS. 4A-4D illustrate different implementations for adjusting a file's delivery parameter from the default first in, first out mechanism. These adjustments can be made using the controls in control window 450. These controls can include an immediate transfer button 465, a scheduled transfer button 470, an up arrow button 455, and a down arrow button 460.

FIGS. 4A and 4B illustrate the use of an immediate transfer delivery parameter. Selecting this delivery parameter can be useful if, for example, a file is immediately needed at a particular device. In the example of FIG. 4A, a hospital administrator can designate data set B for immediate transfer by selecting the file from file transfer queue 205 and selecting button 465 from control window 450. Doing so can update the delivery parameter for data set B in column 315. Upon receiving these inputs, the file transfer manager can move data set B to top position 320 for immediate transfer as illustrated in FIG. 4B. Because top position 320 can be occupied by both data set A and data set B, both files can be transferred immediately to their respective destinations. In some implementations, the file transfer manager can check whether the transfer destinations for data set A and data set B are connected to the network before transferring the files as described above.

FIGS. 4C and 4D illustrate the use of a scheduled transfer date and time as a delivery parameter. Selecting this delivery parameter can be useful to schedule, for example, the deployment of a routine software update to clients connected to network 105. In the example of FIG. 4C, a hospital administrator can schedule the transfer of configuration file B to device 2 to occur on Mar. 16, 2013, at 12:01 a.m. by selecting the file from file transfer queue 205, selecting button 470, and entering the desired date and time. Doing so can update the delivery parameter for configuration file B in column 315. Upon receiving this information, the file transfer manager can compare the current network date and time with the scheduled transfer date and time for configuration file B. When the current network date and time matches the scheduled delivery date and time, the file transfer manager can move configuration file B to top position 320 as illustrated in FIG. 4D. Moving configuration file B to top position 320 leaves a vacancy in queue position 325 which can be filled by data set B. Because top position 320 can be occupied by both data set A and configuration file B, both files can be transferred immediately to their respective destinations. In some implementations, the file transfer manager can check whether the transfer destinations for data set A and configuration file B are connected to the network before transferring the files as described above.

As described above with respect to FIGS. 4B and 4D, top position 320 can be occupied by multiple files. In some implementations, the file transfer manager can limit the number of files that are simultaneously transmitted from file transfer queue 205. Limiting file transmission can be useful in preventing network congestion. This limit can be based on a predetermined maximum number of files or a maximum combined file size. In some implementations, other limits can be used including, for example, a maximum network throughput value and the like.

Although the examples of FIGS. 4A-4D describe the moving of a file only to top position 320, a hospital administrator can move files to any location within file transfer queue 205 by dragging and dropping files to their desired locations. In some implementations, up and down arrow buttons 355 and 360, respectively, can be used to manually shift the position of a file throughout the queue.

FIG. 5 illustrates a flowchart 500 for transferring a file from a file transfer queue. At 505, a file transfer manager can maintain a file transfer queue. The file transfer queue can have multiple queue positions, and each queue position can store one more files. Each file can be associated with a transfer destination device and a delivery parameter. In some implementations, the delivery parameter can indicate, for example, that a file should be transferred immediately, at a scheduled date and time, or in accordance with a default first in, first out mechanism.

At 510, the file transfer manager can move a file to a top position of the file transfer queue based on the file's delivery parameter. This can happen, for example, if a file's delivery parameter indicates that it should be immediately transferred. In some implementations, a file can be moved to the top position if its scheduled transfer date and time matches the current network date and time.

At 515, the file transfer manager can determine whether the transfer destination devices of the files in the top position are connected to the network. The file transfer manager can, for example, ping these devices and listen for a reply. If a reply is received, the file transfer manager can optionally ask the devices whether they are willing to accept a file.

At 520, the file transfer manager can transfer the files in the top position based on the determination made at 515. If, for example, the file transfer manager receives a reply after pinging a particular transfer destination device, the file transfer manager can transfer the file to the device. If, however, no reply is received, then the file transfer manager can delete the entry for the file from the file transfer queue without transferring the file.

One or more aspects or features of the subject matter described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device (e.g., mouse, touch screen, etc.), and at least one output device.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. A method comprising:
maintaining a file transfer queue of at least one file, the file transfer queue comprised of a plurality of queue positions including at least a top position, each queue position storing one of the files, and each file associated with a transfer destination device and a delivery parameter, the delivery parameter indicating a delivery priority;
moving at least one of the files to the top position based on the associated delivery parameter;
determining that each of the transfer destination devices associated with the at least one file in the top position is connected to a network; and
transferring the at least one file in the top position to the associated transfer destination device based on the determining.

2. The method of claim 1, wherein the determining further comprises:
querying each of the transfer destination devices associated with the at least one file in the top position for an indication of whether the transfer destination device is willing to accept a file.

3. The method of claim 1, wherein the moving of the at least one file to the top position occurs when the associated delivery parameter indicates that the at least one file is to be immediately transferred.

4. The method of claim 1, wherein the moving of the at least one file to the top position occurs when the associated delivery parameter of the at least one file indicates a delivery date and delivery time that matches the current network date and current network time.

5. The method of claim 1, wherein the delivery parameter indicates a default delivery methodology.

6. The method of claim 5, wherein the default delivery methodology is a first in, first out mechanism.

7. The method of claim 1, further comprising:
limiting a number of files that are simultaneously transferred.

8. The method of claim 7, wherein the limiting is based on predetermined maximum number of files, a predetermined maximum combined file size, or a maximum network throughput value.

9. The method of claim 1, further comprising:
shifting any remaining files in the file transfer queue by a single queue position towards the top position after the transferring.

10. The method of claim 1, wherein at least one of the transfer destination devices comprises a medical device, and wherein the at least one file comprise a data set, which when accessed by the medical device causes at least one configuration setting of the medical device to be modified.

11. The method of claim 10, wherein the medical device is a syringe pump, and wherein the data set comprises a syringe list specifying at least one setting associated with at least one syringe.

12. The method of claim 1, wherein at least one of the transfer destination devices comprises a medical device, and wherein the at least one file comprises: a software update, or a firmware update.

13. A non-transitory computer-readable medium containing instructions to configure a processor to perform operations comprising:
maintaining a file transfer queue of at least one file, the file transfer queue comprised of a plurality of queue positions including at least a top position, each queue position storing one of the files, and each file associated with a transfer destination device and a delivery parameter, the delivery parameter indicating a delivery priority;
moving at least one of the files to the top position based on the associated delivery parameter;
determining that each of the transfer destination devices associated with the at least one file in the top position is connected to a network; and
transferring the at least one file in the top position to the associated transfer destination device based on the determining.

14. The non-transitory computer-readable medium of claim 13, wherein the moving of the at least one file to the top position occurs when the associated delivery parameter indicates that the at least one file is to be immediately transferred.

15. The non-transitory computer-readable medium of claim 13, wherein the moving of the at least one file to the top position occurs when the associated delivery parameter of the at least one file indicates a delivery date and delivery time that matches the current network date and current network time.

16. The non-transitory computer-readable medium of claim 13, the operations further comprising:
limiting a number of files that are simultaneously transferred.

17. A system comprising:
a processor; and
a memory, wherein the processor and the memory are configured to perform operations comprising:
maintaining a file transfer queue of at least one file, the file transfer queue comprised of a plurality of queue positions including at least a top position, each queue position storing one of the files, and each file associated with a transfer destination device and a delivery parameter, the delivery parameter indicating a delivery priority;
moving at least one of the files to the top position based on the associated delivery parameter;
determining that each of the transfer destination devices associated with the at least one file in the top position is connected to a network; and
transferring the at least one file in the top position to the associated transfer destination device based on the determining.

18. The system of claim 17, wherein the moving of the at least one file to the top position occurs when the associated delivery parameter indicates that the at least one file is to be immediately transferred.

19. The system of claim 17, wherein the moving of the at least one file to the top position occurs when the associated delivery parameter of the at least one file indicates a delivery date and delivery time that matches the current network date and current network time.

20. The system of claim 17, the operations further comprising:
limiting a number of files that are simultaneously transferred.
